(19) United States
(12) Patent Application Publication
(10) Pub. No.: US 2007/0076640 A1
(43) Pub. Date: Apr. 5, 2007

(54) Method and system for indicating wireless interconnectivity

(76) Inventors: Jeffery D. Bonta, Arlington Heights, IL (US); Avinash Joshi, Orlando, FL (US); Peggy K. Matson, Arlington Heights, IL (US); Sivakumar Muthuswamy, Tower Lakes, IL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/240,847

(22) Filed: Sep. 30, 2005

(51) Int. Cl. H04B 7/00

(52) U.S. Cl. 370/310; 455/41.2; 455/509; 455/115.1

(57) ABSTRACT

A method and system for indicating wireless interconnectivity between at least two electronic devices is useful for configuring wireless networks. The method includes activating at each device a wireless networking communication interface (step 305). At least one other device is then identified at each device (step 310). It is then determined at each device whether a wireless communication channel is operative with an identified at least one other device (step 315). An alarm is then triggered at each device that does not have a wireless communication channel operative with an identified at least one other device (step 320).

### FIELD OF THE INVENTION

The present invention relates generally to wireless networking, and in particular to indicating interconnectivity between multiple devices in a wireless network.

### BACKGROUND

Ad hoc wireless networking of electronic devices for home and office use is growing in popularity. Standards such as Bluetooth for wireless personal area networking (WPAN) and IEEE 802.11b, or WiFi (wireless fidelity), for wireless local area networking (WLAN) are increasingly used in consumer electronic products. For example, a home may have operating within it a computer, a wireless router for Internet access, a television, an amplifier, one or more speakers and a digital video recorder, all wirelessly networked and capable of ad hoc communications.

Wireless networks are often preferred to wired networks such as Ethernet networks for a variety of reasons. The absence of wiring can simplify device interconnection procedures and also significantly improve the aesthetics of a room that has numerous networked devices. Further, wirelessly networked devices can be moved relative to each other much more easily, as networking wires do not need to be routed through or along walls or hidden behind furniture.

However, as with many new technologies, setting up wireless networks can be intimidating to consumers who are unfamiliar with such networks. Further, even sophisticated and experienced users of wireless equipment can be challenged to find strategic locations for some wireless devices that enable ideal ad hoc communications between various devices in a network. Labor intensive trial and error procedures are sometimes required, involving iterative measurements of received signal strengths. Even when such procedures are successful, movement of one networked device can again require positional readjustment of various other networked devices, particularly where the networked devices are operating near the limits of their wireless range.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a schematic diagram of an ad hoc communication network comprising a plurality of electronic devices according to an embodiment of the present invention.

FIG. 2 is a schematic diagram of components of a typical wireless device in a network according to an embodiment of the present invention.

FIG. 3 is a general flow diagram illustrating a method for indicating wireless interconnectivity between at least two electronic devices according to an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to indicating wireless interconnectivity. Accordingly, the apparatus components and method steps have been represented where appropriate by conventional symbols in the drawings, showing only those specific details that are pertinent to understanding the embodiments of the present invention, so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of indicating wireless interconnectivity described herein. The non-processor circuits may include, but are not limited to, a radio receiver, a radio transmitter, signal drivers, clock circuits, power source circuits, and user input devices. As such, these functions may be interpreted as steps of a method to perform indicating wireless interconnectivity. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

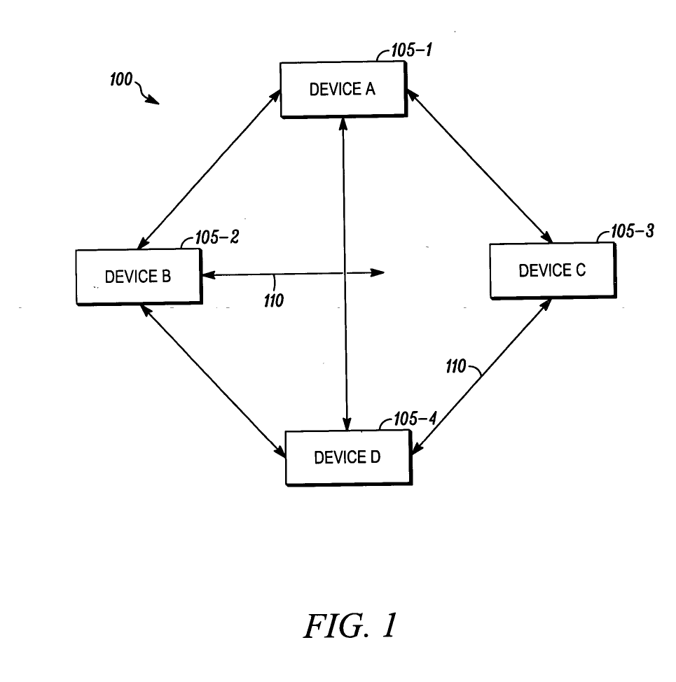

Referring to FIG. 1, a schematic diagram of an ad hoc communication network 100 comprising a plurality of electronic devices 105-n according to an embodiment of the present invention is illustrated. Each line 110 extending from a device 105-n to one or more other devices 105-n represents a functioning wireless communication interface operatively connecting two devices 105-n together. The interfaces may conform, for example, to wireless standards such as IEEE 802.11 or Bluetooth.

In FIG. 1, the line 110 extending from the “B” device 105-2 toward the “C” device 105-3 does not reach all the way to the “C” device 105-3, indicating that the “C” device 105-3 is out of range of a transmitter of the “B” device 105-2. Because the “A”, “B”, and “D” devices 105-n are all within range of each other, the “C” device 105-3 merely needs to be moved closer to the “B” device 105-2 to establish a network topology where every device 105-n is directly connected to every other device.

However, in a real-world wireless network environment, possibly involving many more devices 105-n than the four devices 105-n shown in FIG. 1, determining which devices 105-n in a network 100 are not communicating effectively with other devices 105-n can be difficult and time consuming. The present invention provides an alarm feature that can be used intuitively to assist in establishing and maintaining interconnectivity between multiple network devices 105-n.

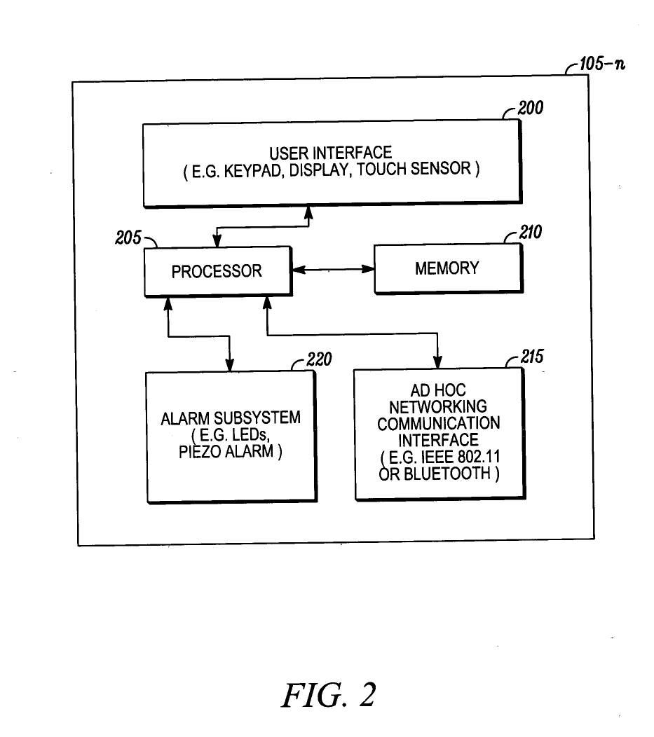

Referring to FIG. 2, a schematic diagram of components of a typical wireless device 105-n operating within a network 100 according to an embodiment of the present invention is illustrated. The device 105-n may be any type of electronic apparatus having wireless communication capability, such as a computer, printer, television, stereo, speaker, camera, digital recorder, games console, wireless router, and the like. The device 105-n can include various elements such as the following: a user interface 200 such as a keypad, display or touch sensor; a processor 205 to control operating features of the device 105-n; a memory 210 to store for example data and computer program code components; and an ad hoc networking communication interface 215, which conforms to a wireless standard such as IEEE 802.11 or Bluetooth and enables the device 105-n to communicate wirelessly with other devices 105-n. According to an embodiment of the present invention, each device 105-n in the network 100 further includes an alarm subsystem 220 that is activated when a wireless communication channel is not operative with another device 105-n in the network 100.

The user interface 200, memory 210, communication interface 215 and alarm subsystem 220 are each operatively connected to the processor 205. Those skilled in the art will appreciate that the memory 210 may comprise various types of memory such as a random access memory (e.g., static random access memory (SRAM)), read only memory (e.g., programmable read only memory (PROM)), electrically erasable programmable read only memory (EPROM)), or hybrid memory (e.g., FLASH) as is well known in the art. The processor 205 then accesses a computer useable medium in the memory 210, which medium includes computer readable program code components configured to cause the device 105-n to execute the functions of the present invention.

Referring again to FIG. 1, consider an example where the “A”, “B”, “C” and “D” devices 105-n are each a component in a wireless home entertainment system, and the devices 105-n correspond to, respectively, a television, a digital recorder, and two speakers. Consider also that each device 105-n includes each of the elements shown in FIG. 2. A purchaser of the entertainment system who seeks to assemble the system may first position each device 105-n in an initial location in a room and provide a power supply to each device 105-n. Next, the wireless communication interface 215 at each device 105-n is activated. The communication interface 215 may be activated in various ways including automatically when power is supplied to a device 105-n, or a user may initiate activation of the communication interface 215 using, for example, the user interface 200.

Next, the other devices 105-n in the network 100 are identified at each device 105-n. For example, the entertainment system may require that each device 105-n be capable of wirelessly communicating with one or more other devices 105-n in the network 100. As will be appreciated by those of ordinary skill in the art, each device 105-n can be programmed to include a specific communication address for each of the other three devices 105-n in the network 100. Such addresses may be entered, for example, at a factory where the devices 105-n of the entertainment system are assembled and packaged. Or, if a network 100 includes ad hoc components that are purchased separately, the addresses of other devices 105-n in the network 100 may be entered manually at each device 105-n using the user interface 200.

Each device 105-n then determines whether a wireless communication channel is operative with each of the other devices 105-n in the network 100. Such determinations can be made for example by a first device 105-1 transmitting periodic “ping” messages to the other devices 105-n that need to be in wireless communication with the first device 105-1. After a predetermined time period, if a corresponding “pong” message is not received at the first device 105-1 from each of the other devices 105-n, then first device 105-1 will activate its alarm subsystem 220.

Thus in FIG. 1 the “A” device 105-1 will be programmed to include the respective wireless address for each of the “B”, “C”, and “D” devices 105-n. The “A” device 105-1 then determines whether a wireless communication channel is operative between “A”-“B”, “A”-“C”, and “A”-“D”. If all of the wireless communication channels are operative, then the “A” device 105-1 is properly connected to the network 100 and is able to communicate directly with all three other devices 105-n.

Similarly, the “B” device 105-2 will be programmed to include the respective wireless address for each of the “A”, “C”, and “D” devices 105-n. The “B” device 105-2 will then determine whether a wireless communication channel is operative between “B”-“A”, “B”-“C”, and “B”-“D”. However, as indicated in FIG. 1 by the line 110 between the “B” and “C” devices 105-n, a wireless communication channel may be inoperative between the “B” and “C” devices 105-n. Therefore, the “B” device 105-2 will trigger its alarm subsystem 220 to indicate to a user that at least one designated communication channel for the “B” device 105-2 is not operative. Further, the “C” device 105-3 will determine that a wireless communication channel is not operative between “C”-“B”. Therefore, the “C” device 105-3 will also trigger its alarm subsystem 220 to indicate to a user that at least one designated communication channel for the “C” device 105-3 is not operative. So, in the present example of an entertainment system, if the “B” and “C” devices 105-n each correspond to a speaker in the system, the alarm subsystem 220 at each speaker would activate and a user will know immediately that the speakers need to be moved closer together to bring them within range of each other, and furthermore that all other components in the entertainment system are properly wirelessly interconnected.

The alarm subsystems 220 according to embodiments of the present invention can include various types of alarm indicators such as Light Emitting Diodes (LEDs), display screens, or audible alarms including piezoelectric components or speakers. For example, an alarm subsystem 220 can include as alarm indicators a simple green LED to indicate that an alarm is inactive and a red LED to indicate that an alarm is active. More sophisticated alarm indicators may include for example an audible alarm that changes tone or flashing LEDs that change a rate of flashing based on a wireless signal quality. For example, a device 105-n may detect a repetitive communication such as a Received Signal Strength Indicator (RSSI) that measures wireless signal strength received from another device 105-n. A signal strength above a certain threshold is indicated by an LED that is continuously on. If a detected signal strength decreases below the threshold, the LED will flash rapidly at first, and then slower if the signal strength drops' further. Other attributes of signal quality such as fading, phase cancellation, delay spread, and cochannel interference can be monitored in the same manner. The flashing LEDs thus effectively act as a “heartbeat”, indicating the health of the wireless communication channels operating at a particular device 105-n.

Still other embodiments of the present invention include an alarm subsystem 220 having a display that indicates an identity of all other devices 105-n in the network 100 with which a particular device 105-1 is intended to communicate. Such a display may also indicate a received signal strength associated with each other device 105-n, or identify any other device 105-n that is unconnected to a particular device 105-1.

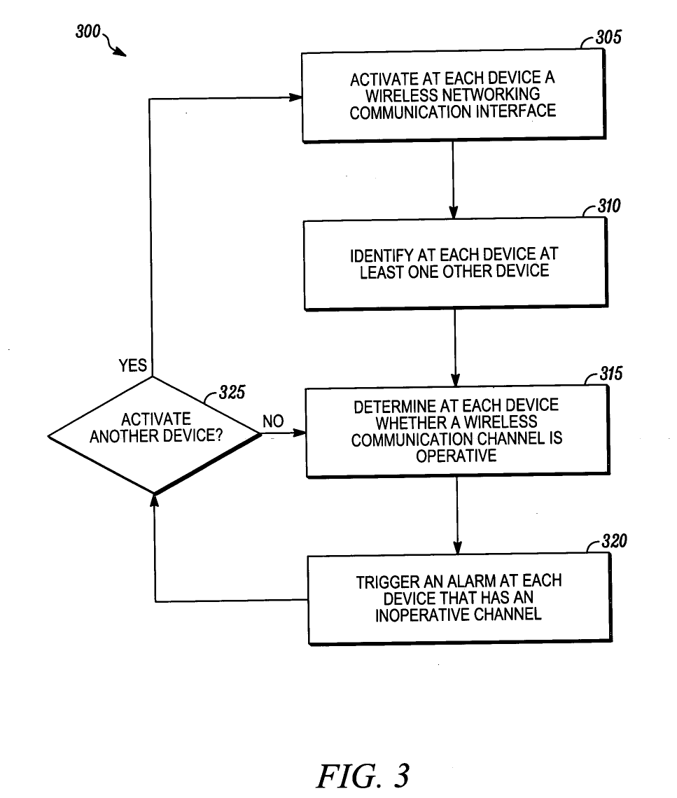

Referring to FIG. 3, a general flow diagram of a method 300 for indicating wireless interconnectivity between at least two electronic devices 105-n according to an embodiment of the present invention is illustrated. First, at step 305, at each device 105-n a wireless networking communication interface 215 is activated. As described above, an interface 215 may be activated manually by a user or automatically when power is supplied to a device 105-n. At step 310, at each device 105-n at least one other device 105-n is identified. For example, a first device 105-1 may have an address of each of the other devices 105-n in a network 100, to which the first device 105-1 needs to be wireless connected, programmed into the first device 105-1. At step 315, it is determined at each device 105-n whether a wireless communication channel is operative with an identified at least one other device 105-n. Thus if a first device 105-1 needs to be wirelessly connected to a second device 105-2 in a network 100, then it is determined at the first device 105-1 whether a wireless communication channel is operative between the first device 105-1 and the second device 105-2, and it is also determined at the second device 105-2 whether a wireless communication channel is operative between the second device 105-2 and the first device 105-1. At step 320, an alarm is triggered at each device 105-n that does not have a wireless communication channel operative with an identified at least one other device 105-n. Thus where first and second devices 105-n in a network 100 are identified as requiring an operative wireless communication channel between them, and such a channel is not operative, then alarm subsystems 220 at both devices 105-n will be activated. The method 300 then cycles to continue monitoring the network 100. At step 325, if a new device 105-n needs to be added to the network 100, the method 300 returns to step 305 where the new device 105-n is activated; otherwise the method 300 returns to step 315 and determines again whether a wireless communication channel is operative with an identified at least one other device 105-n. As described herein, whether a communication channel is operative may be a relative determination, and may include gradients based on channel quality.

Advantages of the present invention thus include significant savings in time and effort when configuring and positioning devices 105-n in a wireless network 100. Embodiments of the present invention enable network users to employ intuitive alarm indicators to quickly assess the status of various wireless channels between devices 105-n in a network 100. If one or more wireless communication channels are not performing adequately, based on information obtained using the present invention a network user can readily adjust parameters in a network 100, such as the relative positioning of devices 105-n or the transmitting power of a device 105-n, to improve channel performance.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method for indicating wireless interconnectivity between at least two electronic devices, the method comprising:
activating at each device a wireless networking communication interface;
identifying at each device at least one other device;
determining at each device whether a wireless communication channel is operative with an identified at least one other device; and
triggering an alarm at each device that does not have a wireless communication channel operative with an identified at least one other device.

2. The method of claim 1 wherein the devices are selected from the group consisting of: computers, televisions, stereo receivers, digital recorders, speakers, amplifiers, keyboards, monitors, home appliances, and office appliances.

3. The method of claim 1 wherein the alarm comprises a light, an LED, a speaker, or a display screen.

4. The method of claim 1 wherein the wireless networking communication interface conforms to a standard chosen from a group comprising an 802.11 standard, and a Bluetooth standard.

5. The method of claim 1 wherein identifying at each device at least one other device comprises programming in each device an address of at least one other device.

6. The method of claim 1 wherein determining at each device whether a wireless communication channel is operative comprises detecting at each device a Received Signal Strength Indicator (RSSI) transmitted from an identified at least one other device.

7. The method of claim 1 wherein determining whether a wireless communication channel is operative with an identified at least one other device comprises receiving a repetitive communication from the identified at least one other device.

8. The method of claim 1 wherein an output of the alarm changes based on a wireless signal quality.

9. The method of claim 8 wherein a rate of flashing of an alarm indicator changes, a color of an alarm indicator changes, or a tone of an audible alarm indicator changes.

10. The method of claim 1 wherein the alarm indicates an identity of at least one other device.

11. A system for indicating wireless interconnectivity, comprising:
at least two electronic devices, each device comprising:
a processor;
a memory operatively connected to the processor;
a wireless networking communication interface operatively connected to the processor; and
an alarm subsystem operatively connected to the processor for alerting the status of a wireless communication channel associated with at least one other device.

12. The system of claim 11, wherein the memory of each device comprises a computer useable medium having computer readable program code components configured to cause each device, respectively, to:
activate its wireless communication interface;
identify at least one other device;
determine whether a wireless communication channel is operative with an identified at least one other device; and
trigger the alarm subsystem when a wireless communication channel is not operative with an identified at least one other device.

13. The system of claim 11 wherein the devices are selected from the group consisting of: computers, televisions, stereo receivers, digital recorders, speakers, amplifiers, keyboards, monitors, home appliances, and office appliances.

14. The system of claim 11 wherein the alarm subsystem comprises a light, an LED, a speaker, or a display screen.

15. The system of claim 11 wherein the wireless networking communication interface conforms to a standard chosen from a group comprising an 802.11 standard, and a Bluetooth standard.

16. The system of claim 12 wherein identifying at each device at least one other device comprises programming in each device an address of at least one other device.

17. The system of claim 12 wherein determining at each device whether a wireless communication channel is operative comprises detecting at each device a Received Signal Strength Indicator (RSSI) transmitted from an identified at least one other device.

18. The system of claim 12 wherein determining whether a wireless communication channel is operative with an identified at least one other device comprises receiving a repetitive communication from the identified at least one other device.

19. The system of claim 11 wherein an output of the alarm subsystem changes based on a wireless signal quality.

20. The system of claim 19 wherein a rate of flashing of an alarm indicator changes, a color of an alarm indicator changes, or a tone of an audible alarm indicator changes.

21. The system of claim 11 wherein the alarm subsystem indicates an identity of at least one other device.

22. A system for indicating wireless interconnectivity between at least two electronic devices, the system comprising:
means for activating at each device a wireless networking communication interface;
means for identifying at each device at least one other device;
means for determining at each device whether a wireless communication channel is operative with an identified at least one other device; and
means for triggering an alarm at each device that does not have a wireless communication channel operative with an identified at least one other device.
